(19) United States
(12) Patent Application Publication
(10) Pub. No.: US 2005/0205754 A1
(43) Pub. Date: Sep. 22, 2005

(54) Construction components incorporating pliant sealing edges

(76) Inventor: Kyozaburo Takagi, Centerville, OH (US)

Correspondence Address: DINSMORE & SHOHL LLP;One Dayton Centre, Suite 1300, One South Main Street, Dayton, OH, 45402-2023, US

(21) Appl. No.: 11/056,944

(22) Filed: Feb. 11, 2005

Related U.S. Application Data
(60) Provisional application No. 60/544,096, filed on Feb. 12, 2004.
(60) Provisional application No. 60/544,184, filed on Feb. 12, 2004.

(51) Int. Cl. E04G 17/00; B29C 33/76

(52) U.S. Cl. 249/210; 249/183; 249/185

(57) ABSTRACT

A construction component is provided comprising an elongate body and at least one pliant sealing edge. The elongate body defines an extruded cross-sectional profile that defines a panel-forming face configured such that an un-cured material may be cured against and subsequently released from the panel-forming face in a substantially unobstructed manner. The panel-forming face defines a pair of lateral edges extending along a longitudinal dimension of the elongate body. At least one of the lateral edges incorporates a pliant sealing edge extending along the longitudinal dimension of the elongate body. The pliant sealing edge and the panel-forming face define integral portions of the extruded cross-sectional profile and are formed of materials characterized by substantially different degrees of structural rigidity such that material forming the pliant sealing edge is substantially less rigid than material forming the panel-forming face.

### CROSS-REFERENCE TO RELATED APPLICATIONS

This application claims the benefit of U.S. Provisional Application Ser. Nos. 60/544,096 (FUU 0040 MA), filed Feb. 12, 2004, and 60/544,184 (FUU 0041 MA), filed Feb. 12, 2004.

### BACKGROUND OF THE INVENTION

The present invention relates to tilt-up, precast, cast-in-place, and other similar construction techniques where un-cured material, e.g., concrete, is introduced into a form and cured to assume the shape of the form. More particularly, the present invention relates to the configuration of the form and other construction components utilized with the form to supplement to the basic shape defined by the form. Examples of such components include form bulkheads, rustications or reveals, single chamfers, double chamfers, rounded chamfers, angled chamfers, rounded corner pieces, single and multi-component recess chamfers used at the edges of window and door openings, drip edge chamfers, and any other construction component configured to alter the cured shape of the material introduced into the form. The specific manner in which particular forms are constructed, the steps involved in introducing un-cured material into the form, and the steps associated with utilizing cured objects are beyond the scope of the present invention and can be readily gleaned from the art, including the published patent documents incorporated by reference herein.

Construction components according to the present invention may abut or be otherwise arranged upon an interior surface of a form to alter the interior boundaries of the form. Where the particular form at issue is configured upon a panel-forming surface, such as a concrete panel-forming slab, construction components according to the present invention may abut a surface of the panel-forming slab bounded by the form, an interior surface of the form, or both the slab and the form. U.S. Pat. App. Pub. Nos. 2003/0141624, 2003/0115816, 2003/0084632, 2003/0025235, 2003/0025064, U.S. Pat. Nos. 6,398,180, 6,279,868, the disclosures of which are incorporated herein by reference, present some examples of specific types of construction components falling within the scope of the present invention and should not be taken to limit the scope of the present invention.

### BRIEF SUMMARY OF THE INVENTION

In accordance with one embodiment of the present invention, a construction component is provided comprising an elongate body and at least one pliant sealing edge. The elongate body defines an extruded cross-sectional profile that defines a panel-forming face configured such that an un-cured material may be cured against and subsequently released from the panel-forming face in a substantially unobstructed manner. The panel-forming face defines a pair of lateral edges extending along a longitudinal dimension of the elongate body. At least one of the lateral edges incorporates a pliant sealing edge extending along the longitudinal dimension of the elongate body. The pliant sealing edge and the panel-forming face define integral portions of the extruded cross-sectional profile and are formed of materials characterized by substantially different degrees of structural rigidity such that material forming the pliant sealing edge is substantially less rigid than material forming the panel-forming face.

In accordance with another embodiment of the present invention, the extruded cross-sectional profile defines at least one structural discontinuity in a contact plane associated with the pliant sealing edge. The structural discontinuity is configured to allow distortion of the contact plane under pressure applied to the pliant sealing edge from the direction of the panel forming face.

Accordingly, it is an object of the present invention to provide for improvements in schemes related to tilt-up, precast, cast-in-place, and other similar construction techniques where un-cured material, e.g., concrete, is introduced into a form and cured to assume the shape of the form. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of a panel forming system including construction components according to the present invention;

FIGS. 2A-2C are illustrations of three examples of construction components incorporating pliant sealing edges according to the present invention;

FIGS. 3, 3A, and 3B are general illustrations of one type of construction component according to the present invention;

FIGS. 4, 4A, and 4B are general illustrations of an additional type of construction component according to the present invention;

FIGS. 5, 5A, and 5B are general illustrations of a further type of construction component according to the present invention;

FIGS. 6, 6A, and 6B are general illustrations of another type of construction component according to the present invention; and

FIGS. 7 and 8, illustrate alternative pliant sealing edge configurations according to the present invention.

### DETAILED DESCRIPTION

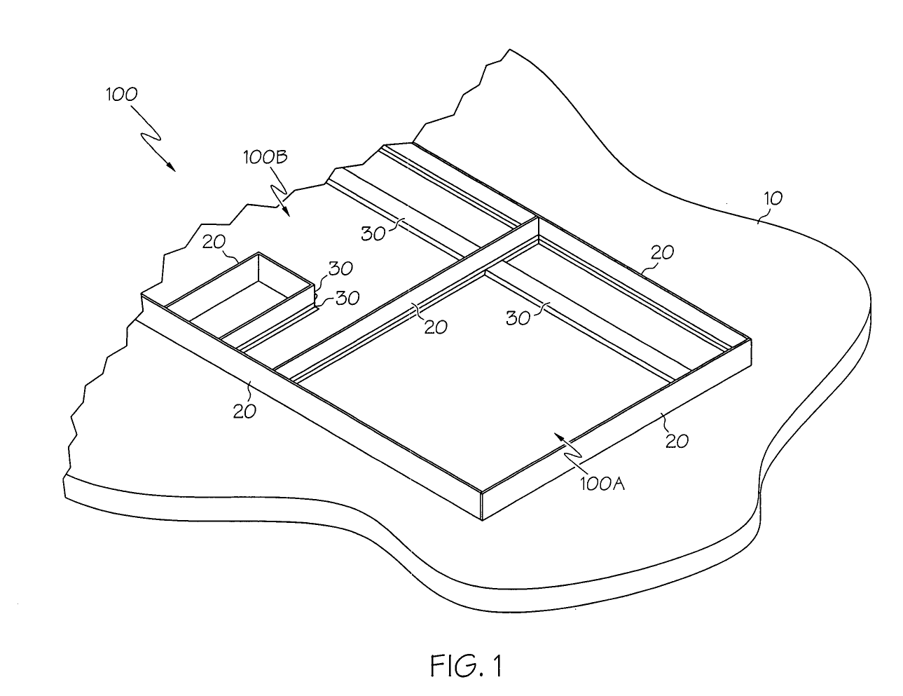

Construction components according to the present invention can be utilized in a variety of contexts. Referring specifically to FIG. 1, a panel forming system 100 is illustrated and comprises a panel forming slab 10 and a plurality of panel forming bulkheads 20 arranged such that an un-cured material, e.g., concrete, can be introduced and contained within the panel forming system 100 in the shape of one or more panels. Individual construction components 30 are included in the panel forming system 100 as a supplement to the remaining components of the panel forming system 100 and are configured to further define the shape of panels cured within the forming system 100.

Each of the various construction components 30 according to the present invention comprises some type of supplemental panel form and can be configured to serve a variety of functions. For example, and not by way of limitation, construction components 30 according to the present invention may comprise a beveled corner chamfer or a rounded corner chamfer positioned at the intersection of a bulkhead 20 and the panel forming slab 10, a double chamfer positioned to receive and support a bulkhead 20 defining the partition between adjacent panel forming sections 100A, 100B of the panel forming system 100, a rustication positioned to define a decorative strip in panels cured within the panel forming sections 100A, 100B, a drip edge form positioned to define drainage features in a cured panel, or any other conventional or yet to be developed supplemental panel form where the features of the present invention may find utility. Accordingly, it should be appreciated that the particular form and function of the variety of construction components contemplated by the present invention are beyond the scope of the present invention. Similarly, the concepts of the present invention should not be limited to particular features or characteristics of specific types of construction components.

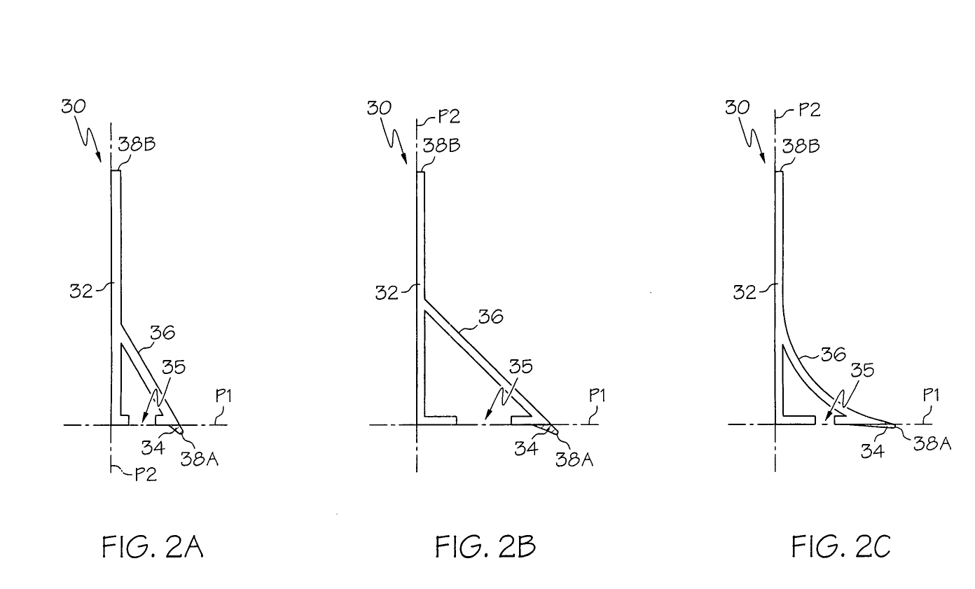

Referring initially to FIGS. 2A-2C, one type of construction component 30 according to the present invention is illustrated. The construction component 30 illustrated in FIGS. 2A-2C is of the corner chamfer variety and would typically be positioned at the intersection of a panel forming slab 10 and a bulkhead 20 of a panel forming system. In the case of FIG. 2A, the component 30 would serve to define a chamfer having a relatively steep angle along one of the edges of a panel cured within one of the panel forming sections 100A, 100B. The component 30 of FIG. 2B would define a chamfer characterized by a less severe angle, e.g., about 45 degrees while the component 30 of FIG. 2C would define a rounded corner chamfer.

Each construction component 30 illustrated in FIGS. 2A-2C comprises an elongate body 32 defining an extruded cross-sectional profile and at least one pliant sealing edge 34. The extruded cross-sectional profile defines a panel-forming face 36 configured such that an un-cured material may be cured against and subsequently released from the panel-forming face 36 in a substantially unobstructed manner. In this manner, the construction components 30 are left in the form when a cured panel is removed from one of the panel forming sections 100A, 100B, etc. It is contemplated that the panel-forming face 36 can comprise a multifaceted surface, a planar surface, a curved surface, or combinations thereof.

The panel-forming face 36 defines a pair of lateral edges 38A, 38B extending along a longitudinal dimension of the elongate body 32. At least one of the lateral edges 38A, 38B incorporates a pliant sealing edge 34 that also extends along the longitudinal dimension of the elongate body 32. In the illustrated embodiment, the pliant sealing edge 34 is incorporated in the lateral edge 38B that would interface with the panel forming slab 10 in one of the panel forming sections 100A, 100B. The opposite lateral edge 38A would interface with one of the bulkheads 20.

The pliant sealing edge 34 and the panel-forming face 36 define integral portions of the extruded cross-sectional profile and are formed of materials characterized by substantially different degrees of structural rigidity. In this manner, material forming the pliant sealing edge 34 is substantially less rigid than material forming the panel forming face 36. As a result, construction components 30 according to the present invention maintain a high degree of structural integrity because the panel forming face 36 is substantially rigid. In addition, construction components 30 according to the present invention are characterized by enhanced functionality because the pliant sealing edges 34 incorporated therein provide for enhanced sealing properties, particularly where they interface with slabs 10 or bulkheads 20 of inconsistent quality.

For example, a construction component 30 that is substantially linear along its longitudinal dimension may be limited to some extent in its ability to interface with a panel forming slab 10 including slight undulations or irregularities in its surface. By providing a pliant sealing edge 34 at the lateral edge 38A of the component 30, the ability of the component to vary from a substantially linear orientation along the longitudinal axis of the component 30 at the lateral edge 38 is enhanced. In addition, pliant sealing edges 34 also help account for instances where variations in the longitudinal linearity of the component 30 would allow un-cured material to seep beyond the bounds defined by the construction component 30.

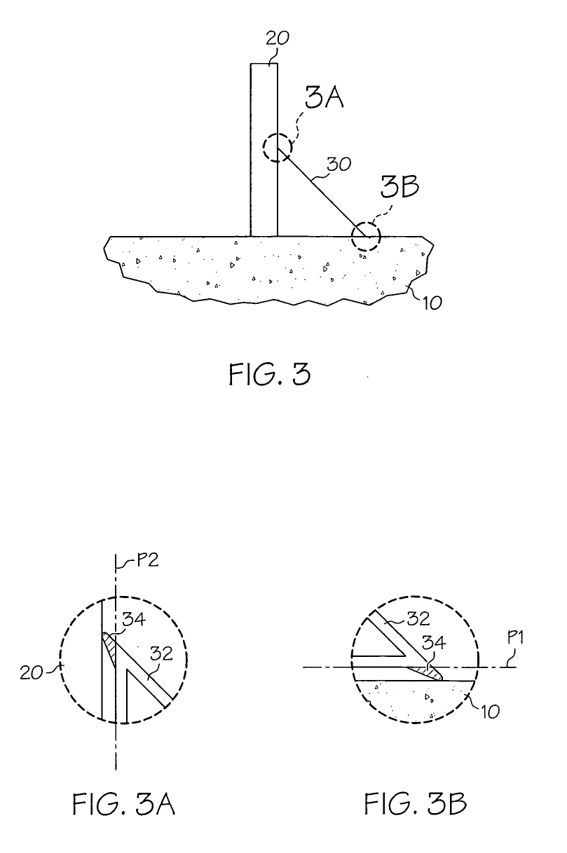

Before turning to the more general illustrations of FIGS. 3-6, it is noted that FIGS. 2A-C illustrate an additional feature of the present invention. Specifically, each of the illustrated components 30 includes an extruded cross-sectional profile that defines a relatively rigid contact plane P1 beyond which the pliant sealing edge 34 is configured to extend. In the embodiments of FIGS. 2A-C, the contact plane P1 would generally abut the plane of the panel forming slab 10. A structural discontinuity 38 is defined in the contact plane P1 and is configured to allow distortion of the contact plane P1 under pressure applied to the pliant sealing edge 34. As a result, the degree to which the lateral edge 38A can vary from a substantially linear orientation along the longitudinal axis of the component 30 is enhanced and the construction component 30 can interface with irregular surfaces with more reliability. For the purposes of defining and describing the present invention, it is noted that the contact plane P1 is referred to herein as being relatively rigid because it is defined by the relatively rigid material of the component 30, as opposed to the relatively pliant material of the sealing edge 34.

Referring to FIGS. 3, 3A, and 3B, one type of construction component 30 according to the present invention will define a pair of substantially orthogonal, relatively rigid contact planes P1, P2. It is noted that the construction component 30 is illustrated in FIG. 3 in a general manner, without specific illustration of its structure, because the illustrated embodiment relates broadly to a variety of construction components that define a pair of substantially orthogonal, relatively rigid contact planes P1, P2. Referring specifically to FIGS. 3A and 3B, each of the respective pliant sealing edges 34 is configured to extend beyond the associated contact plane P1, P2. Of course, as is illustrated in FIGS. 2A-2C, it is contemplated that the construction component 30 may be provided with a single sealing edge 34 associated with only one of the contact planes. For example, and not by way of limitation, it is contemplated that a suitable pliant sealing edge 34 extending beyond the associated contact plane P1, P2 by at least about 1/32″ (0.75 mm) will provide enhanced sealing properties.

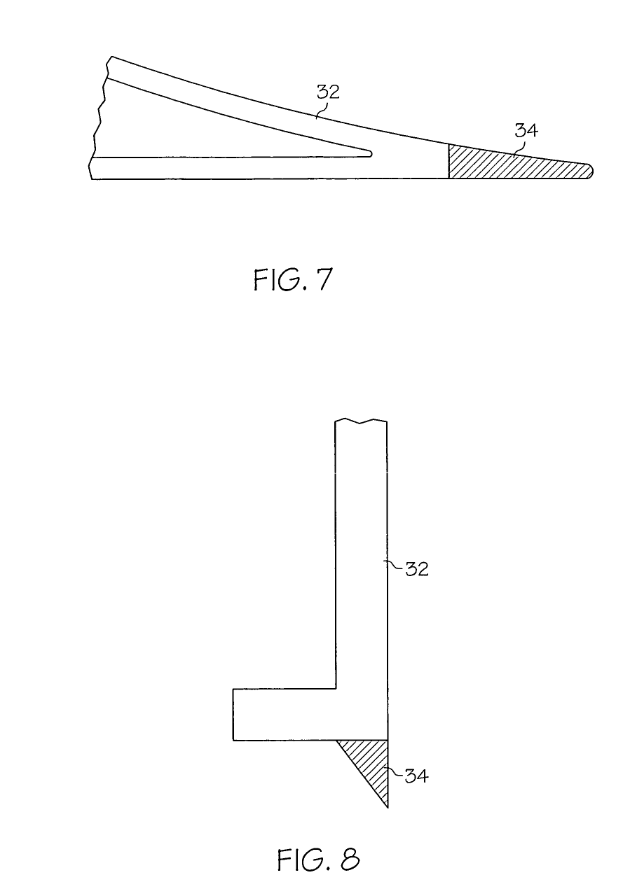

Referring briefly to FIG. 7, it is also noted that enhanced sealing properties can also be achieved by configuring pliant sealing edges 34 to extend along one or both of the pair of substantially orthogonal, relatively rigid contact planes P1, P2. It is contemplated that it may be necessary to ensure that pliant sealing edges 34 according to this embodiment of the present invention extend along the associated contact plane for at least about ⅛″ (3 mm). FIG. 8 illustrates a further variation of a pliant sealing edge configuration. Additional variations of the sealing edge shape are contemplated but are not illustrated herein for the sake of clarity and brevity.

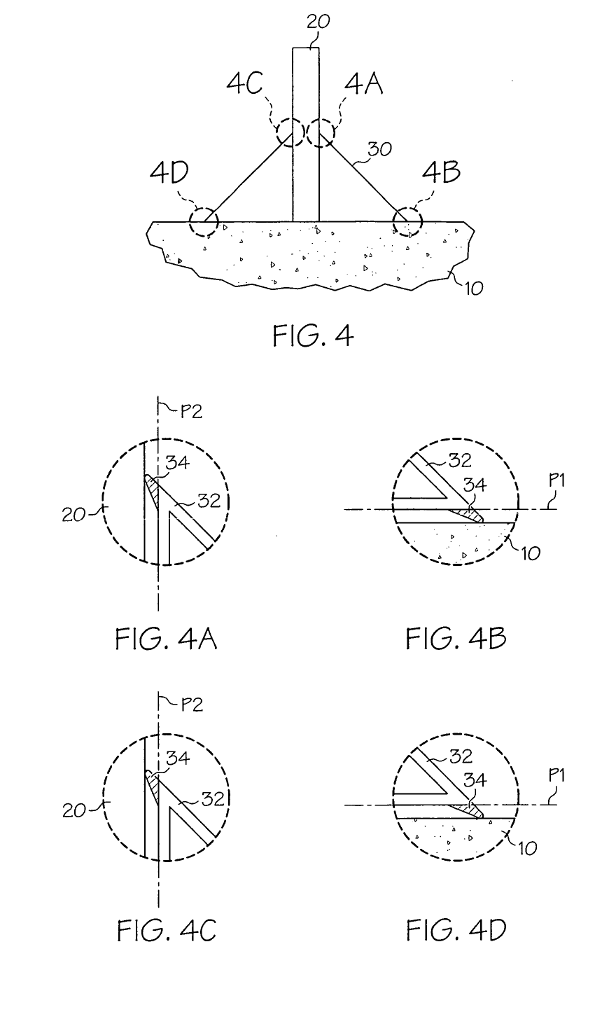

FIGS. 4 and 4A-4D illustrate a class of construction components where the component 30 is configured to define a double chamfer, i.e., a chamfered surface in a longitudinal edge of adjacent panels formed in adjacent panel forming sections 100A, 100B of the panel forming system 100. In many instances, the component 30, illustrated generally in a schematic nature in FIG. 4, will be constructed to support the bulkhead 20 defining the partition between the adjacent panel forming sections 100A, 100B. The extruded cross-sectional profile of the type of component 30 illustrated in FIG. 4 defines a pair of discrete panel-forming faces 36 and first and second sets of substantially orthogonal, relatively rigid contact planes P1, P2.

As is illustrated in FIGS. 4 and 4A-4D, respective pliant sealing edges 34 can be configured to extend beyond one or both of the substantially orthogonal, relatively rigid contact planes P1, P2 in each of the first and second sets of contact planes. Where respective pliant sealing edges 34 are configured to extend beyond the contact plane P2 in each of the first and second sets of contact planes, they can be configured to define opposed pliant sealing edges spaced apart by an amount sufficient to define a form receiving space therebetween. As is illustrated in FIG. 4, this form receiving space supports the bulkhead 20 defining the partition between the adjacent panel forming sections 100A, 100B illustrated in FIG. 1.

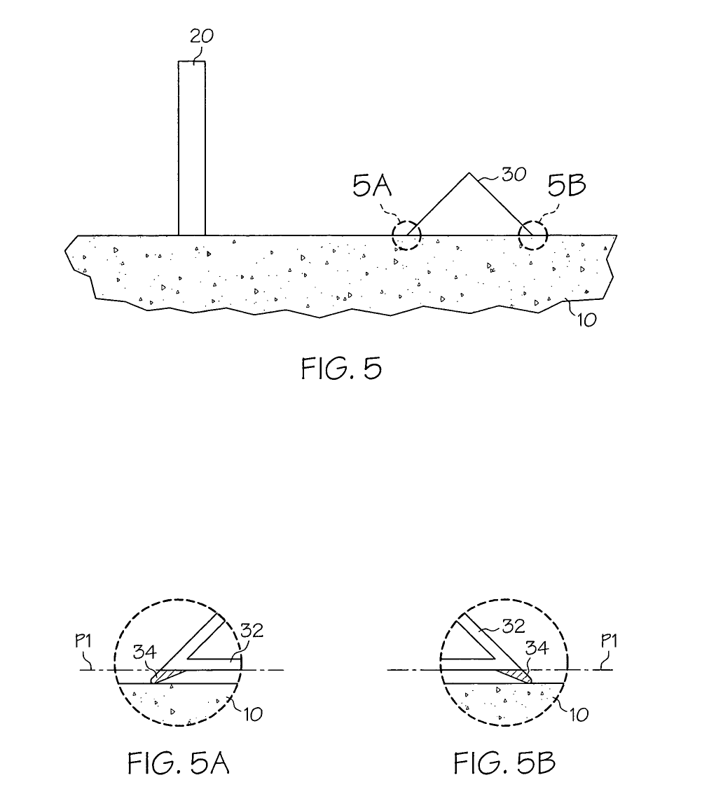

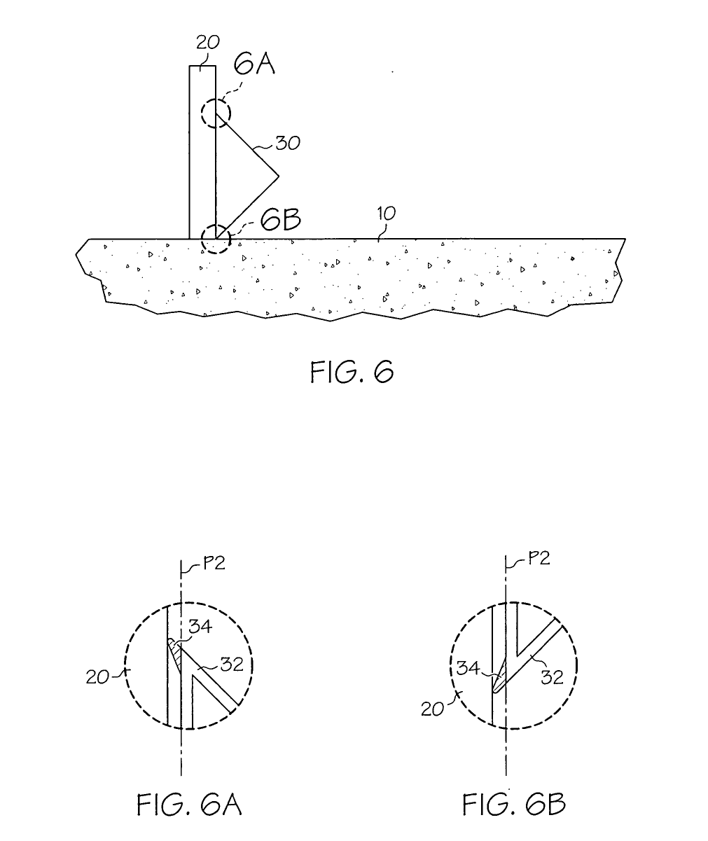

FIGS. 5 and 6 illustrate a class of construction components where the component 30 is configured to define a single, relatively rigid contact plane P1. For example, referring to FIG. 1, construction components falling within this class are often referred to as rustications, rustifications, or reveal moldings and are configured to rest on the panel forming slab 10 and extend across the panel forming section 100A between the lateral or top and bottom bulkheads 20. Used in this manner, the component 30 will create a vertical or horizontal reveal band in the cured panel at some predetermined point along its height or width dimension. As is illustrated in FIG. 6, it is also contemplated that construction components defining a single contact plane P1, can also be configured to rest primarily upon a bulkhead portion 20 of a panel forming system.

In any event, it is contemplated that the construction components 30 illustrated in FIGS. 5 and 6 can be configured such that one or both of the lateral edges 38A, 38B incorporates a pliant sealing edge 34 extending along the longitudinal dimension of the elongate body 32. It is contemplated that the pliant sealing edges 34 can be configured to extend beyond the single contact plane P1, as is illustrated in FIGS. 5A, 5B, 6A, and 6B, or along the single contact plane P1, as is illustrated in FIG. 7.

Construction components according to the present invention are typically formed from a plastic material, e.g., polyvinyl chloride (PVC), low or high-density polyethylene or polypropylene, acrylics, polycarbonates, thermoplastic elastomers, etc. Because the construction components according to the present invention include relatively rigid and relatively pliant materials, they may be fabricated by generating a co-extrusion defining a cross section including relatively rigid portions and relatively pliant portions. The relatively pliant portions may be extruded using softer plastics like soft, flexible thermoplastic elastomers, or other relatively soft materials.

For the purposes of defining and describing the present invention it is noted that a body that defines an extruded cross sectional profile defines a substantially uniform cross section that extends along substantially the entire length of the body. It is contemplated that bodies defining an extruded cross sectional profile may, to a limited extent, embody variations in the uniformity of the cross section due to fabrication process errors or post fabrication process steps. For example, holes may be drilled in an extruded member in specific locations after the member is extruded. Similarly, cuts or cutouts may be formed in the extruded member or the extruded member may be bent or deformed after it is extruded.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise a construction component according to the present invention or a panel forming system incorporating a construction component 30 according to the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A device comprising a construction component, said construction component comprising an elongate body and at least one pliant sealing edge, wherein:
said elongate body defines an extruded cross-sectional profile;
said extruded cross-sectional profile defines a panel-forming face configured such that an un-cured material may be cured against and subsequently released from said panel-forming face in a substantially unobstructed manner;
said panel-forming face defines a pair of lateral edges extending along a longitudinal dimension of said elongate body;
at least one of said lateral edges incorporates a pliant sealing edge extending along said longitudinal dimension of said elongate body; and
said pliant sealing edge and said panel-forming face define integral portions of said extruded cross-sectional profile and are formed of materials characterized by substantially different degrees of structural rigidity such that material forming said pliant sealing edge is substantially less rigid than material forming said panel-forming face.
contact plane discontinuity

2. A device as claimed in claim 1 wherein:
said extruded cross-sectional profile defines at least one relatively rigid contact plane;
said pliant sealing edge is configured to extend beyond said relatively rigid contact plane;
said extruded cross-sectional profile defines at least one structural discontinuity in said relatively rigid contact plane associated with said pliant sealing edge; and
said structural discontinuity in said relatively rigid contact plane is configured to allow distortion of said contact plane under pressure applied to said pliant sealing edge.

3. A device as claimed in claim 1 wherein:
said extruded cross-sectional profile defines at least one relatively rigid contact plane;
said pliant sealing edge is configured to extend along said relatively rigid contact plane;
said extruded cross-sectional profile defines at least one structural discontinuity in said relatively rigid contact plane associated with said pliant sealing edge; and
said structural discontinuity in said relatively rigid contact plane is configured to allow distortion of said contact plane under pressure applied to said pliant sealing edge.

4. A device as claimed in claim 1 wherein said extruded cross-sectional profile defines a pair of substantially orthogonal, relatively rigid contact planes.

5. A device as claimed in claim 4 wherein said pliant sealing edge is configured to extend beyond one of said pair of substantially orthogonal, relatively rigid contact planes.

6. A device as claimed in claim 4 wherein said pliant sealing edge is configured to extend beyond one of said pair of substantially orthogonal, relatively rigid contact planes by at least about 1/32″ (0.75 mm).

7. A device as claimed in claim 4 wherein:
each of said lateral edges incorporates a pliant sealing edge extending along said longitudinal dimension of said elongate body; and
respective pliant sealing edges are configured to extend beyond each of said pair of substantially orthogonal, relatively rigid contact planes.

8. A device as claimed in claim 4 wherein said pliant sealing edge is configured to extend along one of said pair of substantially orthogonal, relatively rigid contact planes.

9. A device as claimed in claim 4 wherein said pliant sealing edge is configured to extend along one of said pair of substantially orthogonal, relatively rigid contact planes for at least about ⅛″ (3 mm).

10. A device as claimed in claim 4 wherein:
each of said lateral edges incorporates a pliant sealing edge extending along said longitudinal dimension of said elongate body; and
respective pliant sealing edges are configured to extend along each of said pair of substantially orthogonal, relatively rigid contact planes.

11. A device as claimed in claim 1 wherein said extruded cross-sectional profile defines a pair of discrete panel-forming faces and first and second sets of substantially orthogonal, relatively rigid contact planes.

12. A device as claimed in claim 11 wherein respective pliant sealing edges are configured to extend beyond one of said substantially orthogonal, relatively rigid contact planes in each of said first and second sets of contact planes.

13. A device as claimed in claim 11 wherein respective pliant sealing edges are configured to extend beyond one of said substantially orthogonal, relatively rigid contact planes in each of said first and second sets of contact planes to define opposed pliant sealing edges spaced apart an amount sufficient to define a form receiving space therebetween.

14. A device as claimed in claim 11 wherein:
said pliant sealing edge is configured to extend beyond one of said substantially orthogonal, relatively rigid contact planes in said first set of contact planes; and
an additional pliant sealing edge is configured to extend beyond one of said substantially orthogonal, relatively rigid contact planes in said second set of contact planes, parallel to said contact plane in said first set of contact planes.

15. A device as claimed in claim 11 wherein said pliant sealing edge is configured to extend beyond both of said substantially orthogonal, relatively rigid contact planes in each of said first and second sets of contact planes.

16. A device as claimed in claim 1 wherein said extruded cross-sectional profile defines said panel-forming face and a single, relatively rigid contact plane.

17. A device as claimed in claim 16 wherein:
each of said lateral edges incorporates a pliant sealing edge extending along said longitudinal dimension of said elongate body; and
each of said pliant sealing edges are configured to extend beyond said single contact plane.

18. A device as claimed in claim 16 wherein:
each of said lateral edges incorporates a pliant sealing edge extending along said longitudinal dimension of said elongate body; and
each of said pliant sealing edges are configured to extend beyond said single contact plane by at least about 1/32″ (0.75 mm).

19. A device as claimed in claim 16 wherein:
each of said lateral edges incorporates a pliant sealing edge extending along said longitudinal dimension of said elongate body; and
each of said pliant sealing edges are configured to extend along said single, relatively rigid contact plane.

20. A device as claimed in claim 16 wherein:
each of said lateral edges incorporates a pliant sealing edge extending along said longitudinal dimension of said elongate body; and
each of said pliant sealing edges are configured to extend along said single, relatively rigid contact plane by at least about ⅛″ (3 mm).

21. A device as claimed in claim 1 wherein said panel-forming face comprises a multifaceted surface, a planar surface, a curved surface, or combinations thereof.

22. A device as claimed in claim 1 wherein:
said device comprises a plurality of components in addition to said construction component; and
said additional components and said construction component are configured as a panel forming system such that said un-cured material can be contained within said panel forming system in the shape of a panel.

23. A device as claimed in claim 22 wherein said plurality of additional components comprise a panel forming slab and a plurality of panel forming bulkheads.

24. A device as claimed in claim 23 wherein said construction component comprises a profiled supplemental panel form.

25. A device as claimed in claim 23 wherein said construction component comprises a panel forming component selected from a beveled corner chamfer, a rounded corner chamfer, a double chamfer, a rustication, and a drip edge form.
